(19) United States
(12) Patent Application Publication
(10) Pub. No.: US 2026/0016611 A1
(43) Pub. Date: Jan. 15, 2026

(54) CONSTRAINING SPECTRAL DECOMPOSITION USING PEAKS

(71) Applicant: Halliburton Energy Services, Inc., Houston, TX (US)

(72) Inventors: Gregory Joseph Schmid, Houston, TX (US); Jeffrey James Crawford, Houston, TX (US)

(21) Appl. No.: 19/045,472

(22) Filed: Feb. 4, 2025

Related U.S. Application Data
(60) Provisional application No. 63/670,362, filed on Jul. 12, 2024.

(51) Int. Cl. G01V 5/10

(52) U.S. Cl. CPC G01V 5/101

(57) ABSTRACT

A method comprises obtaining, via one or more sensors positioned in a wellbore formed in a subsurface formation, a full spectrum of the subsurface formation at a first depth, wherein the full spectrum is decomposed into peak components and continuum background components. The method comprises identifying one or more elements based on the peak components. The method comprises modifying a generalized set of elemental standards to generate a constrained set of elemental standards based on the one or more elements. The method comprises performing a fitting of the full spectrum to the constrained set of elemental standards to determine an elemental composition at the first depth of the subsurface formation.

### FIELD

The disclosure generally relates to hydrocarbon recovery and more particularly to determining the elemental composition of a subsurface formation.

### BACKGROUND

In hydrocarbon recovery operations, wellbores are formed in subsurface formations. The elemental composition of the subsurface formation may affect many aspects of the hydrocarbon recovery operations such as wellbore placement in a subsurface formation. The elemental composition of the subsurface formation may be determined by spectral decomposition. Spectral decomposition may be utilized to break down a complex signal (such as a gamma ray signal) into its constituent components to identify and quantify the elements present in the subsurface formation at a given depth. The observed spectrum (i.e., the spectral output of the subsurface formation) may be fit to a set of standards to determine the elemental composition of the subsurface formation. The standards may be derived from a reference spectrum obtained from a pure element or from the spectral unfolding of a well-characterized compound under controlled conditions. These spectra may be used as benchmarks or references to identify and quantify the elemental compositions.

### BRIEF DESCRIPTION OF THE DRAWINGS

Implementations of the disclosure may be better understood by referencing the accompanying drawings.

FIGS. 1A-1B are schematics depicting example well systems, according to some implementations.

FIG. 2 is a flowchart depicting example operations to determine the elemental composition of a subsurface formation, according to some implementations.

FIG. 3 is a chart depicting a full spectrum fit-to-standard, according to some implementations.

FIGS. 4A-4B are charts depicting example peak components, according to some implementations.

FIG. 5 is a chart depicting example inelastic peak components acquired in 10 laboratory formations, according to some implementations.

FIG. 6 is a chart depicting example ratios of a Silicon count window and a Carbon count window, according to some implementations.

FIG. 7 is a chart depicting a full spectrum fit to a constrained set of elemental standards, according to some implementations.

FIG. 8 is a block diagram depicting an example computer, according to some implementations.

### DESCRIPTION

The description that follows includes example systems, methods, techniques, and program flows that embody aspects of the disclosure. However, it is understood that this disclosure may be practiced without these specific details. For instance, this disclosure refers to neutron-induced gamma-ray spectra. The neutron induced gamma rays may be “inelastic”, from neutron scattering reactions on formation nuclei, or “capture”, from thermal neutron capture on formation nuclei. Furthermore, since the measured spectra include both peak and background components, they are referred to as “full” spectra. Aspects of this disclosure can also be applied to any other types of spectra measurements. In other instances, well-known instruction instances, protocols, structures, and techniques have not been shown in detail in order not to obfuscate the description.

Example implementations relate to spectral decomposition to determine the elemental composition of a formation. A spectral output, such as neutron-induced gamma-ray spectra, of a subsurface formation may be obtained during downhole operations (such as drilling, logging, etc.). The neutron-induced gamma-ray spectra may be decomposed, via fitting to a set of elemental standards, to determine the elemental compositions of the formation (i.e., neutron-induced gamma-ray spectroscopy). In some implementations, conventional approaches may decompose the full spectra (either inelastic or capture) via software/firmware into a linear sum of elemental standards. The coefficients in front of the standards may be referred to as “yields”, and may represent the fraction of the measured spectrum that comes from that standard. Although this approach may work well, problems may be encountered when a full, generalized, set of elemental standards are used. For example, the results may be noisy. For instance, the result may include elements at unrealistic yield ratios, or may contain elements that are not present at all. In some implementations, fitting constraints may be utilized to improve the quality of the yields. For example, fitting constraints in conventional operations include constraining the capture spectrum with fitting results from the inelastic spectrum, constraining the inelastic spectrum with fitting results from the capture spectrum, constraining one or more elements base upon expected minerology, constraining one or more elements based upon other logging tool results, etc. However, additional resources may be needed to perform these constraints, and may not improve the accuracy of the spectral decomposition.

In some implementations, peak information may be utilized as constraints in the full spectral decomposition. One or more sensors positioned at a depth in a wellbore may obtain the full spectrum of the subsurface formation at the respective depth. For example, a logging while drilling (LWD) tool may be positioned on a drilling assembly downhole to obtain neutron induced gamma-ray spectra (or any other suitable spectra) while drilling a wellbore, or a wireline tool may be positioned in a wellbore during wireline operations to obtain the neutron induced gamma-ray spectra. The full spectrum may include capture spectrum and inelastic spectrum. The full spectrum may comprise the peak components and continuum background components. In some implementations, the peak components may be separated from the continuum background components. For example, the continuum background components may be separated from the peak components using well known published algorithms such as the Statistical Noise-Inflection Point (SNIP) algorithm to determine the continuum background components and then subtract said continuum background components from the full spectrum to determine the peak components.

Peak information of the peak components may be utilized to identify one or more elements in the full spectrum. The association of peaks with elemental gamma rays may be done by means of energy calibration of the measured spectrum and then association of the peak positions with known elemental transitions as tabulated in published compilations. The peak information may include the centroid of one or more peaks, magnitude of one or more peaks, correlation of two or more peaks within the peak components, or any combination thereof. The elemental information thus derived may then be utilized to constrain the generalized set of elemental standards used in the full fit so as to generate a constrained set of elemental standards. For example, a generalized set of elemental standards may be assumed. Elements that are not present can be removed from the generalized set and elemental standards and elements that are present can be added to the generalized set of elemental standards. This may generate a more optimized set of elemental standards for the full spectrum fit at the depth of interest (i.e., a constrained set of elemental standards). More generally, the strength of a peak relative to another peak (or set of peaks) may provide a constraint equation that may be applied to the fitting process. Additionally, or alternatively, the peak centroids and correlations to other peaks may be exploited.

In some implementations, a downhole operation or attribute in the wellbore may be modified or updated based on the elemental composition of the subsurface formation. For example, an operation (at the surface or downhole) may be performed and/or directed to be performed to change a downhole operation or attribute based on the elemental composition of the subsurface formation at a depth and/or depth interval. For example, attributes of an actual drilling operation in the wellbore may be set based on the elemental composition of the subsurface formation. Examples of such attributes of the actual drilling operation may include inclination, azimuth, drilling parameters (such as weight-on-bit (WOB), torque-on-bit (TOB), etc.). For instance, any one of these attributes may be updated to steer the drill bit in a subsurface formation towards high carbon concentrated areas such that the wellbore is formed in a target zone to optimize future hydrocarbon production.

### Example Well System

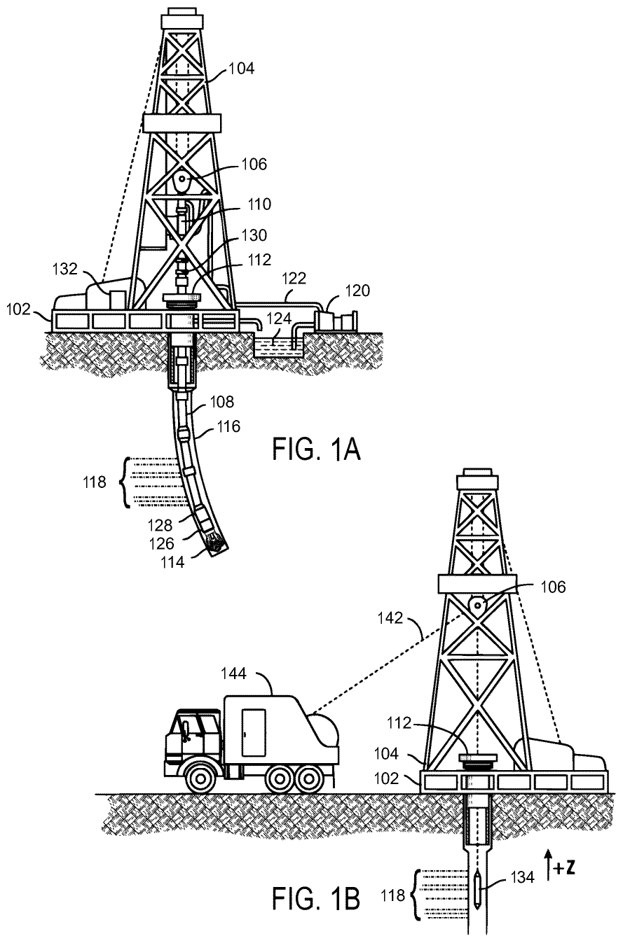

FIGS. 1A-1B are schematics depicting example well systems, according to some implementations. FIG. 1A depicts an example logging while drilling (LWD) system, according to some implementations. A drilling platform 102 supports a derrick 104 having a traveling block 106 for raising and lowering a drill string 108. A kelly 110 supports the drill string 108 as it is lowered through a rotary table 112. A drill bit 114 is driven by a downhole motor and/or rotation of the drill string 108. As the drill bit 114 rotates, it creates a wellbore 116 that passes through various formations 118. A pump 120 circulates drilling fluid through a feed pipe 122 to the kelly 110, downhole through the interior of the drill string 108, through orifices in the drill bit 114, back to the surface via the annulus around the drill string 108, and into a retention pit 124. The drilling fluid transports cuttings from the borehole into the retention pit 124 and aids in maintaining the borehole integrity.

A logging tool 126 can be integrated into the bottom-hole assembly near the drill bit 114. As the drill bit 114 extends the wellbore 116 through the formations 118, the bottom-hole assembly collects measurements relating to the spectral output of the subsurface formation (such as neutron-induced gamma-rays, natural gamma rays, etc.) as well as various other formation properties and information regarding tool orientation and various other drilling conditions. The logging tool 126 may take the form of a drill collar (i.e., a thick-walled tubular that provides weight and rigidity to aid the drilling process). The logging tool 126 can also include one or more navigational packages for determining the position, inclination angle, horizontal angle, and rotational angle of the tool. Such navigational packages can include, for example, accelerometers, magnetometers, and/or sensors.

For purposes of communication, a downhole telemetry sub 128 can be included in the bottom-hole assembly to transfer measurement data to a surface receiver 130 and to receive commands from the surface. Mud pulse telemetry is one common telemetry technique for transferring tool measurements to surface receivers and receiving commands from the surface, but other telemetry techniques can also be used. In some embodiments, the telemetry sub 128 can store logging data for later retrieval at the surface when the logging assembly is recovered.

At the surface, the surface receiver 130 can receive the uplink signal from the downhole telemetry sub 128 and can communicate the signal to a data acquisition module 132. The data acquisition module 132 can include one or more processors, storage mediums, input devices, output devices, software, etc. The data acquisition module 132 can collect, store, and/or process the data received from the logging tool 126 to determine characteristics (e.g., elemental composition, porosity, pore size distribution, permeability, hydrocarbon saturation, etc.) of the formations 118 (as further described herein). For example, the elemental composition of the formations 118 may be determined by the spectral decomposition of the full spectral output obtained by the logging tool 126, where the spectral decomposition is constrained by utilizing peak information of the peak components within the spectral output. The data acquisition module 132 may be local or remote to the drilling platform 102.

At various times during the drilling process, the drill string 108 may be removed from the borehole as shown in FIG. 1B. In particular, FIG. 1B depicts an example wireline system, according to some implementations.

Once the drill string has been removed, logging operations can be conducted using a wireline logging tool 134 (i.e., a sensing instrument sonde suspended by a cable 142 having conductors for transporting power to the tool and telemetry from the tool to the surface). The wireline logging tool 134 may have pads and/or centralizing springs to maintain the tool near the central axis of the borehole or to bias the tool towards the borehole wall as the tool is moved downhole or uphole. The wireline logging tool 134 can also include one or more navigational packages for determining the position, inclination angle, horizontal angle, and rotational angle of the tool. Such navigational packages can include, for example, accelerometers, magnetometers, and/or sensors. In some embodiments, a surface measurement system (not shown) can be used to determine the depth of the wireline logging tool 134.

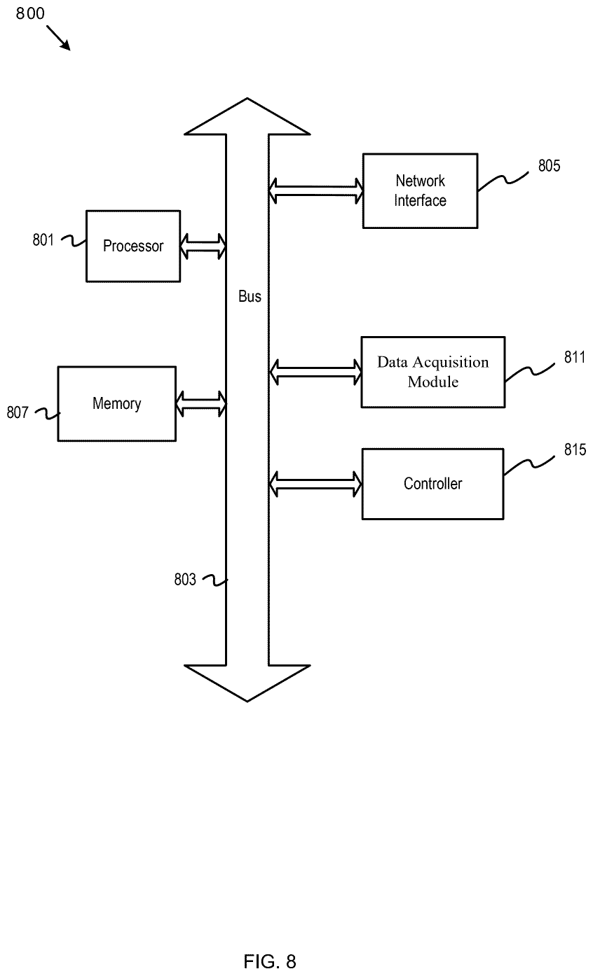

As explained further below, the wireline logging tool 134 can include a logging instrument that collects neutron-induced gamma-ray measurements associated with the formations 118 within the wellbore 116. A logging facility 144 includes a computer, such as those described with reference to data acquisition module 132 and the computer described in FIG. 8, for collecting, storing, and/or processing the measurements gathered by the wireline logging tool 134 (e.g., to determine characteristics such as elemental composition, porosity, pore size distribution, permeability, and/or hydrocarbon saturation of the formations 118).

Although FIGS. 1A and 1B depict specific borehole configurations, it should be understood by those skilled in the art that the present disclosure is equally well suited for use in wellbores having other orientations including vertical wellbores, horizontal wellbores, slanted wellbores, multilateral wellbores, and the like. Also, even though FIGS. 1A and 1B depict an onshore operation, it should be understood by those skilled in the art that the present disclosure is equally well suited for use in offshore operations. Moreover, it should be understood by those skilled in the art that the present disclosure is not limited to the environments depicted in FIGS. 1A and 1B, and can also be used, for example, in other well operations such as non-conductive production tubing operations, jointed tubing operations, coiled tubing operations, combinations thereof, and the like.

### Example Operations

Example operations for determining elemental composition of a subsurface formation with constrained spectral decomposition are now described. This section describes operations associated with some implementations of the invention. In the discussion below, the flow diagrams may be described with reference to the example system presented above. In certain implementations, the operations are performed by executing instructions residing on machine-readable media (e.g., software), while in other implementations, the operations are performed by hardware and/or other logic (e.g., firmware). In some implementations, the operations are performed in series, while in other implementations, one or more of the operations can be performed in parallel. Moreover, some implementations perform less than all the operations shown in the flow diagrams.

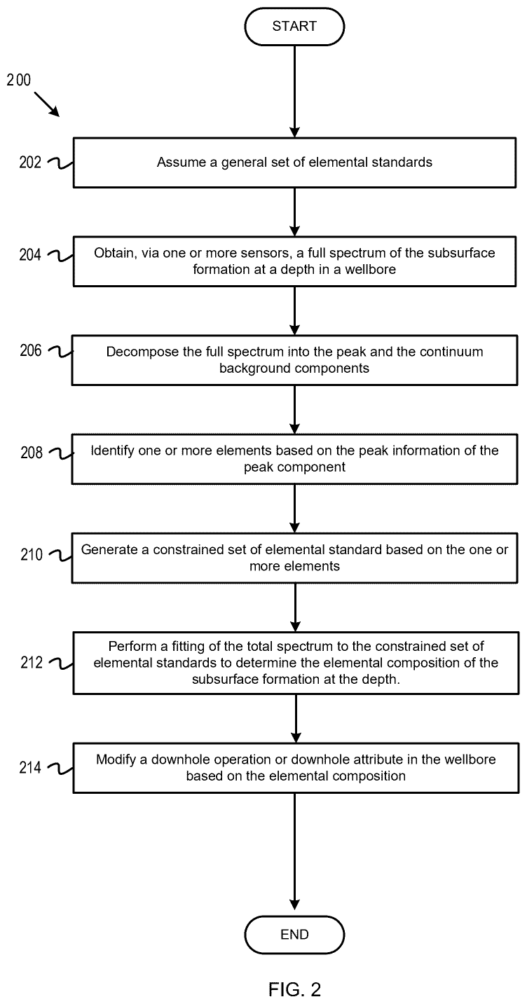

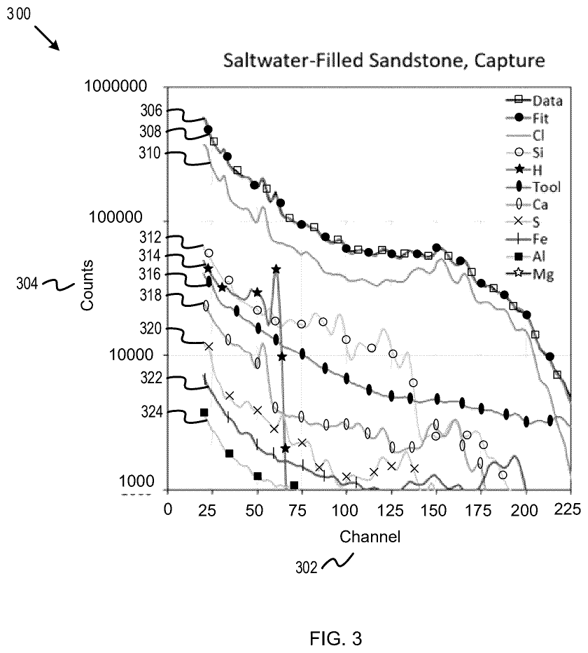

FIG. 2 is a flowchart depicting example operations to determine the elemental composition of a subsurface formation, according to some implementations. The flowchart 200 of FIG. 2 is described in reference to the processor of the data acquisition module 132 of FIG. 1. Additionally, the flowchart 200 is described in reference to FIGS. 3-7 described below. However, other systems and components can be used to perform the operations now described. The operations described in the flowchart 200 may be performed while drilling the wellbore and/or after the wellbore has been drilled. For example, the elemental composition may be determined in real time during the drilling of the wellbore. The operations of the flowchart 200 may be repeated for each depth, or at any suitable depth interval in the wellbore. For example, the elemental composition may be determined every 6 inches, foot, 10 feet, 100 feet, etc. The operations of the flowchart 200 begin at block 202.

At block 202, the processor of the data acquisition module 132 may assume a general set of elemental standards.

At block 204, the processor of the data acquisition module 132 may obtain, via one or more sensors, a full spectrum of the subsurface formation at a depth in the wellbore. The one or more sensors (such as spectrometers) may include sensors of an LWD tool (or any other suitable tool) positioned downhole while drilling a wellbore. The sensors may be positioned on a wireline tool deployed in a wellbore during wireline operations. The full spectrum may include a complete range of detected signals across different wavelengths, energies, etc. The full spectrum may include neutron-induced gamma-ray spectra (both capture spectrum and inelastic spectrum), gamma ray spectra, etc. For instance, the full spectrum may include a comprehensive view of all the radiation detected by a spectrometer over a range of interest. The full spectrum may include peak components of elements present in the subsurface formation at the respective depth, continuum background components (i.e., signal from the tool itself), noise, etc.

To help illustrate, FIG. 3 is a chart depicting a full spectrum fit-to-standard, according to some implementations. FIG. 3 includes a chart 300 of a full spectrum that is already fit-to-standard acquired in a saltwater-filled sandstone formation. The chart 300 includes an x-axis 302 and a y-axis 304. The x-axis 302 is the channel which corresponds to the energy level, typically measured in Mega-electronvolts (MeV). The y-axis 304 is the count, indicating the number of detected interactions at a the corresponding energy (x-axis 302). The full spectrum is fit-to-standard, depicted by the fit 306 and the data 308. The fit-to-standard full spectrum includes a number of elements including Chlorine 310, Silicon 312, Hydrogen 314, Calcium 318, Sulfur 320, Iron 322, Aluminum 324, and Magnesium. Additionally, the background continuum components from the tool 316 are also included in the full spectrum. Since there is no prior knowledge regarding the full spectrum in question, all 9 standards (the aforementioned elements and the background continuum) may be included in the fitting. This may be considered a generalized set of standards. However, only 4 are actually present in the saltwater-filled sandstone (Chlorine 310, Silicon 312, Hydrogen 314, and the tool 316). The other 5 standards may just provide a “fitting noise”. As described below, constraints may be applied to the fit to optimize the set of elemental standards to reduce the noise. The chart 300 depicts a fit performed prior to applying constraints. In some implementations, the fit may not be performed until after the constraints are applied.

At block 206, the data acquisition module 132 may decompose the full spectrum into the peak components and the continuum background components. In some implementations, the continuum background components may be determined using the Statistical Noise-Inflection Point (SNIP) algorithm. The continuum background components may then be subtracted out from the full spectrum to generate the peak components. The SNIP algorithm is only one example for separating the peak components from the continuum background components. Any other suitable method may be used for generating the peak components out of the full spectrum.

The peak information of the peaks present in the peak components may be useful in optimizing the set of elemental standards to reduce the noise. For example, the peaks present in the peak components may indicate which elements are present in the subsurface formation at the depth from which the full spectrum was acquired. The peak information may include the peak centroids, peak magnitude, correlation of other peaks, etc.

At block 208, the data acquisition module 132 may identify one or more elements based on the peak information of the peak components. The peak information may be compared to the generalized set of elemental standards peak information to identify the elements. For example, the peak information may indicate which elements are present in the full spectrum and/or which elements are not present in the full spectrum.

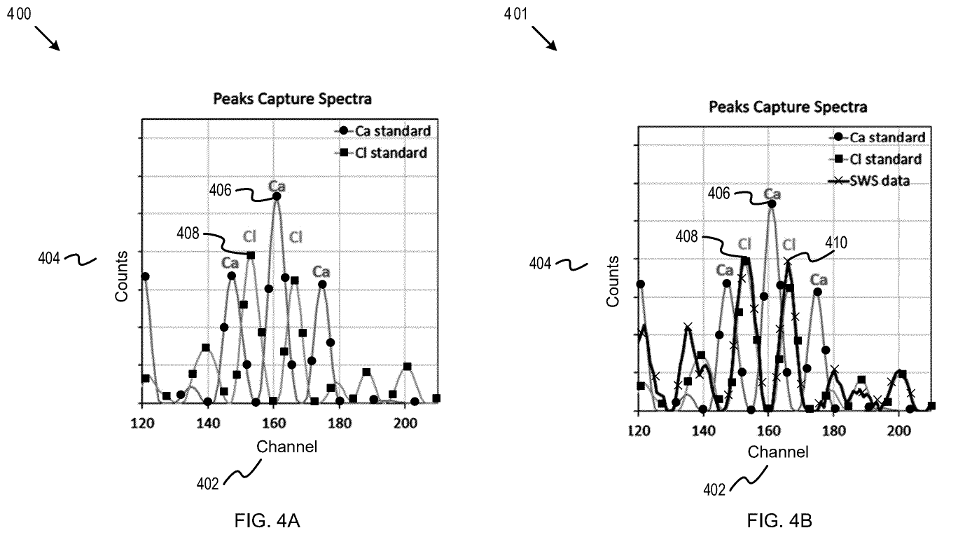

One example of utilizing the peak information is differentiating between elements, such as Calcium and Chlorine in the capture spectra. To help illustrate, FIGS. 4A-4B are charts depicting example peak components, according to some implementations. FIG. 4A includes a chart 400 of a calcium standard 406 and a chlorine standard 408. The chart 400 includes an x-axis 402 and a y-axis 404. The x-axis 402 is the channel which corresponds to the energy level, typically measured in Mega-electronvolts (MeV). The y-axis 404 is the count, indicating the number of detected interactions at the corresponding energy (x-axis 402). Both Calcium and Chlorine in the capture spectra have strong capture peaks around 1.95 MeV (approximately channel 153) and this may cause ambiguity in the fitting. As shown, the Calcium standard 406 and Chlorine standard 408 are out of phase and distinguishable from one another in the high energy region (approximately channels 120-200).

FIG. 4B includes a chart 401 of the Calcium standard 406, the Chlorine standard 408 and the measured peak components 410 overlaid (which may be derived from the full saltwater-filled sandstone capture data from FIG. 3). The chart 400 includes an x-axis 402 and a y-axis 404. The x-axis 402 is the channel which corresponds to the energy level, typically measured in Mega-electronvolts (MeV). The y-axis 404 is the count, indicating the number of detected interactions at a the corresponding energy (x-axis 402). As shown, the peak components are in phase with the Chlorine standard 408, indicating Chlorine is present, but Calcium is not. This conclusion may be quantified by calculating the centroids of all peaks present in the high energy region and looking for a signature of Chlorine or Calcium.

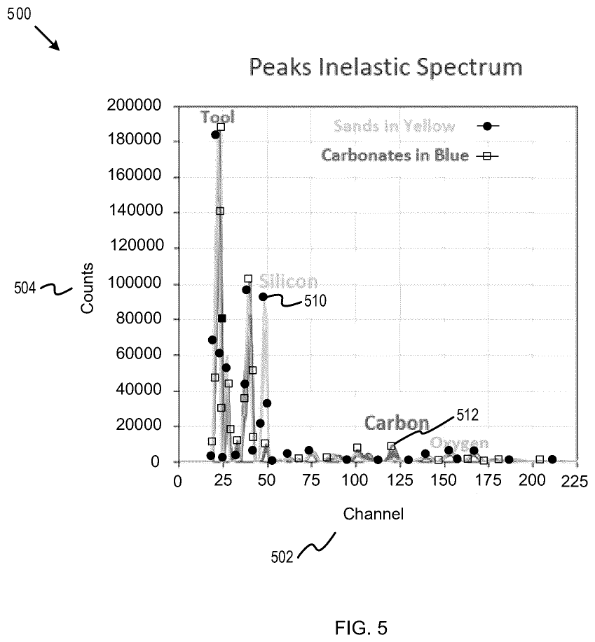

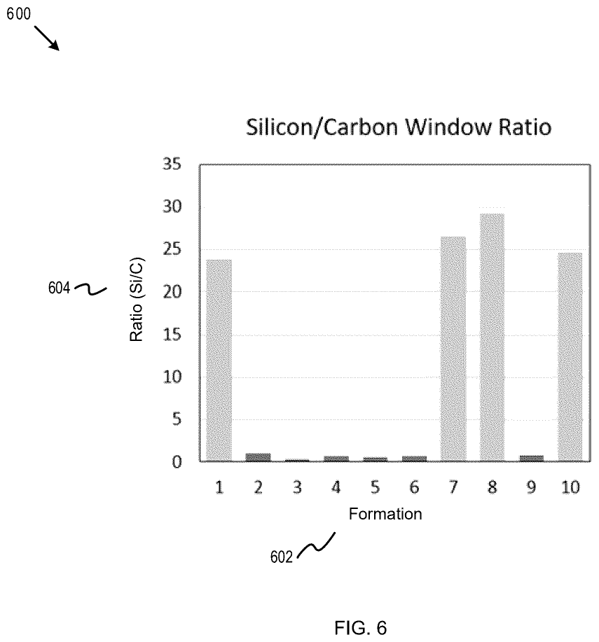

Another example of utilizing the peak information to determine the presence or absence of an element is to compare the count ratios of the elemental peaks. For example, to determine the presence or absence of Calcium, the ratios of the Silicon peak and the Carbon peak in the inelastic may be compared (calcium being associated with carbon and thus with this ratio). To help illustrate, FIG. 5 is a chart depicting example inelastic peak components acquired in 10 laboratory formations, according to some implementations. FIG. 5 includes a chart 500 of peaks spectra for 10 laboratory formations. The chart 500 includes an x-axis 502 and a y-axis 504. The x-axis 502 is the channel which corresponds to the energy level, typically measured in Mega-electronvolts (MeV). The y-axis 504 is the count, indicating the number of detected interactions at a the corresponding energy (x-axis 502). The chart 500 of the peaks spectra includes sands 510, indicating the presence of Silicon, and carbonates 512, indicating the presence of Carbon. The Silicon includes a peak at approximately 1.8 MeV (approximately channel 50) and the Carbon includes a peak at approximately 4.4 MeV (approximately channel 120), indicating the presence of sand 510 or carbonate 512, respectively. FIG. 6 is a chart depicting example ratios of a Silicon count window and a Carbon count window, according to some implementations. FIG. 6 includes a chart 600 of a Silicon/Carbon window ratio for the 10 laboratory formations described in FIG. 5. The chart 600 includes an x-axis 602 and a y-axis 604. The x-axis 602 is the formation. The y-axis 604 is the Silicon peak to Carbon peak ratio for the corresponding formation. As shown, the chart 600 indicates if the formation may be a pure sand or pure carbonate (e.g., peak ratio is greater than 23 and less than 1, respectively). If formation 10 is the formation in question (the saltwater-filled sandstone of FIGS. 3 and 4A-4B), it shows a Silicon peak to Carbon peak ratio at about 23. Thus, the formation may be a pure sand, and Calcium is not expected.

Identifying elements that may be present or not present utilizing the peak information of a peak components is not limited to the aforementioned examples. Any suitable peak information or combination of peak information may be utilized to identify one or more elements that are present or not present in the full spectrum. Operations now return to the flowchart 200.

At block 210, the data acquisition module 132 may generate a constrained set of elemental standards based on the one or more elements. The constrained set of elemental standards may include the original (“generalized”) set of elemental standards with elements removed and/or added based on the elements identified in block 206. For example, with reference to the Saltwater-Filled Sandstone sample, it was determined in FIGS. 4A-4B that Calcium was not present in the peak components. Additionally, this was confirmed in FIG. 5. Accordingly, Calcium may be removed from the set of elemental standards.

At block 212, the data acquisition module 132 may perform a fitting of the full spectrum to the constrained set of elemental standards to determine the elemental composition of the subsurface formation at the respective depth. The fitting may be performed by any suitable method, software, etc. such as chi-squared minimization software, least squares fitting, etc.

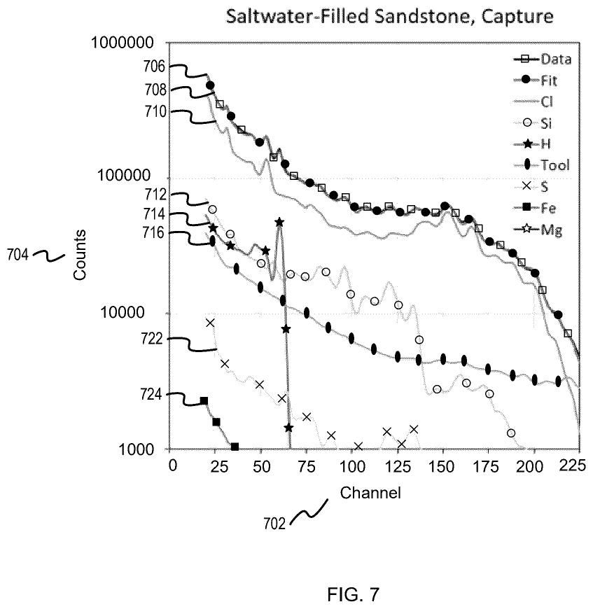

To help illustrate the advantage of an optimized (or “constrained”) set of standards, FIG. 7 is a chart depicting a full spectrum fit to a constrained set of elemental standards, according to some implementations. FIG. 7 includes a chart 700 of a full spectrum that is fit to the set of constrained standards determined in block 210. The chart 700 is the same spectrum as the spectrum of a saltwater-filled sandstone formation depicted in FIG. 3, but fit to the constrained set of elemental standards (i.e., excluding Calcium). The chart 700 includes an x-axis 702 and a y-axis 704. The x-axis 702 is the channel which corresponds to the energy level, typically measured in Mega-electronvolts (MeV). The y-axis 704 is the count, indicating the number of detected interactions at a the corresponding energy (x-axis 702). The fit includes less noise from unwanted elements, such as aluminum, iron, sulfur, and Calcium, and the quality of the fit 708 to the data 706 is still good. The fit now includes Chlorine 310, Silicon 312, Hydrogen 314, Sulfur 322, and Iron 322. The fit still includes the continuum background from the tool 716.

Accordingly, the fit when the full spectrum is fit to the constrained set of elemental standards may indicate the elemental composition of subsurface formation at the respective depth now that the noise from elements not present have been removed. While it is also possible to fit the peaks spectrum itself to peaks elemental standards, such an approach sacrifices a significant number of counts (e.g., 800,000 counts as opposed to 80,000 counts), and may not work well for certain elements which have weak peaks (e.g., Ca in the inelastic spectrum). This is why the preferred approach is fitting to the full spectrum, but using constraints based on the peaks.

At block 214, the data acquisition module 132 may direct an operation to modify a downhole operation or downhole attribute in the wellbore based on the elemental composition. For example, when drilling a wellbore, the elemental composition may assist in steering the drill bit though the subsurface formation. If the elemental composition indicate carbon is present above the drill bit and not below the drill bit (with respect to gravity) when drilling a horizontal wellbore, then downhole operations or downhole attributes may be modified to steer the drill bit up towards the carbon. For instance, the bit face and steering input may be modified to steer the drill bit to the new location, drilling attributes such as WOB, TOB, etc. may be modified, etc. During wireline operations, the elemental composition may indicate the position of saltwater and/or hydrocarbons in a reservoir. Accordingly, completion operations may be modified such that the wellbore is completed (i.e., perforated and hydraulically fractured) in the hydrocarbon bearing zone to maximize hydrocarbon recovery.

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 302-308 of flowchart 300 can be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

### Example Computer

FIG. 8 is a block diagram depicting an example computer, according to some implementations. FIG. 8 depicts a computer 800 for determining rock elastic properties of subsurface formations with transferrable mapping parameters. The computer 800 includes a processor 801 (possibly including multiple processors, multiple cores, multiple nodes, and/or implementing multi-threading, etc.). The computer 800 includes memory 807. The memory 807 may be system memory or any one or more of the above already described possible realizations of machine-readable media. The computer 800 also includes a bus 803 and a network interface 805. The computer 800 can communicate via transmissions to and/or from remote devices via the network interface 805 in accordance with a network protocol corresponding to the type of network interface, whether wired or wireless and depending upon the carrying medium. In addition, a communication or transmission can involve other layers of a communication protocol and or communication protocol suites (e.g., transmission control protocol, Internet Protocol, user datagram protocol, virtual private network protocols, etc.).

The computer 800 also includes a data acquisition module 811 and a controller 815 which may perform the operations described herein. For example, the data acquisition module 811 may separate the peak components from the full spectrum and identify one or more elements within the peak components to constrain the generalized set of elemental standards. The data acquisition module 811 may also perform a fitting of the full spectrum to the constrained set of elemental standards to determine the elemental composition of the subsurface formation. The controller 815 may execute one or more actions based on the elemental composition. The data acquisition module 811 and the controller 815 can be in communication. Any one of the previously described functionalities may be partially (or entirely) implemented in hardware and/or on the processor 801. For example, the functionality may be implemented with an application specific integrated circuit, in logic implemented in the processor 801, in a co-processor on a peripheral device or card, etc. Further, realizations may include fewer or additional components not illustrated in FIG. 8 (e.g., video cards, audio cards, additional network interfaces, peripheral devices, etc.). The processor 801 and the network interface 805 are coupled to the bus 803. Although illustrated as being coupled to the bus 803, the memory 807 may be coupled to the processor 801.

While the aspects of the disclosure are described with reference to various implementations and exploitations, it will be understood that these aspects are illustrative and that the scope of the claims is not limited to them. In general, techniques for determining the hole profile of a wellbore at different measured depth layers described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable sub combination. Moreover, although features may be described as acting in certain combinations and even initially claimed as such, one or more features from a claimed combination may in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

### Example Implementations

Implementation #1: A method comprising: obtaining, via one or more sensors positioned in a wellbore formed in a subsurface formation, a full spectrum of the subsurface formation at a first depth, wherein the full spectrum is decomposed into peak components and continuum background components; identifying one or more elements based on the peak components; modifying a generalized set of elemental standards to generate a constrained set of elemental standards based on the one or more elements; and performing a fitting of the full spectrum to the constrained set of elemental standards to determine an elemental composition at the first depth of the subsurface formation.

Implementation #2: The method of Implementation #1, wherein the full spectrum includes neutron-induced gamma-ray spectra.

Implementation #3: The method of Implementation #1 or 2 further comprising: separating the continuum background components from the full spectrum to obtain the peak components; acquiring peak information from the peak components, the peak information including a centroid of one or more peaks within the peak components, magnitude of one or more peaks within the peak components, correlation of two or more peaks within the peak components, or any combination thereof are used to identify the one or more elements; identifying a presence or absence of the one or more elements to be used in the fitting based on the peak information; and generating the constrained set of elemental standards based on the presence or the absence of the one or more elements.

Implementation #4: The method of any one or more of Implementation #1-3 further comprising: separating the continuum background components from the full spectrum to obtain the peak components; determining centroids of one or more peaks in one or more high energy regions; comparing the centroids to the generalized set of elemental standards to identify the one or more elements; and modifying a the generalized set of elemental standards with the one or more elements to generate the constrained set of elemental standards.

Implementation #5: The method of any one or more of Implementation #1-4 further comprising: separating the continuum background components from the full spectrum to obtain the peak components; determining a ratio of a first count window and a second count window based on the peak components, wherein the first count window corresponds to a gamma ray associated with a first element and the second count window corresponds to the gamma ray associated with a second element; and modifying a the generalized set of elemental standards with the first element or the second element based on an the ratio to generate the constrained set of elemental standards.

Implementation #6: The method of any one or more of Implementation #1-5, wherein the full spectrum is obtained in a capture spectrum or an inelastic spectrum.

Implementation #7: The method of any one or more of Implementation #1-6, further comprising: directing an operation to modify at least one of a downhole operation or a downhole attribute in the wellbore based on the elemental composition.

Implementation #8: The method of any one or more of Implementation #1-7, further comprising: modify at least one of a downhole operation or a downhole attribute in the wellbore based on the elemental composition.

Implementation #9: A system comprising: one or more sensors positioned in a wellbore formed in a subsurface formation; a processor; and a computer-readable medium having instructions stored thereon that are executable by the processor, the instructions including, instructions to obtain, via one or more sensors positioned in a wellbore formed in a subsurface formation, a full spectrum of the subsurface formation at a first depth, wherein the full spectrum is decomposed into peak components and continuum background components, instructions to identify one or more elements based on the peak components, instructions to modify a generalized set of elemental standards to generate a constrained set of elemental standards based on the one or more elements, and instructions to perform a fitting of the full spectrum to the constrained set of elemental standards to determine an elemental composition at the first depth of the subsurface formation.

Implementation #10: The system of Implementation #9, wherein the full spectrum includes neutron-induced gamma-ray spectra.

Implementation #11: The system of Implementation #9 or 10, further comprising: instructions to separate the continuum background components from the full spectrum to obtain the peak components; instructions to acquire peak information from the peak components, the peak information including a centroid of one or more peaks within the peak components, magnitude of one or more peaks within the peak components, correlation of two or more peaks within the peak components, or any combination thereof are used to identify the one or more elements; instructions to identify a presence or absence of the one or more elements to be used in the fitting based on the peak information; and instructions to generate the constrained set of elemental standards based on the presence or absence of the one or more elements.

Implementation #12: The system of any one or more of Implementation #9-11 further comprising: instructions to separate the continuum background components from the full spectrum to obtain the peak components; instructions to determine centroids of one or more peaks in one or more high energy regions; instructions compare the centroids to the generalized set of elemental standards to identify the one or more elements; and instructions to modify a the generalized set of elemental standards with the one or more elements to generate the constrained set of elemental standards.

Implementation #13: The system of any one or more of Implementation #9-12 further comprising: instructions to separate the continuum background components from the full spectrum to obtain the peak components; instructions to determine a ratio of a first count window and a second count window based on the peak components, wherein the first count window corresponds to a gamma ray associated with a first element and the second count window corresponds to the gamma ray associated with a second element; and instructions to modify the generalized set of elemental standards with the first element or the second element based on an the ratio to generate the constrained set of elemental standards.

Implementation #14: The system of any one or more of Implementation #9-13, wherein the full spectrum is obtained in a capture spectrum or an inelastic spectrum.

Implementation #15: The system of any one or more of Implementation #9-14, further comprising: instructions to direct an operation to modify at least one of a downhole operation or a downhole attribute in the wellbore based on the elemental composition.

Implementation #16: A non-transitory, computer-readable medium having instructions stored thereon that are executable by a processor, the instructions comprising: instructions to obtain, via one or more sensors positioned in a wellbore formed in a subsurface formation, a full spectrum of the subsurface formation at a first depth; wherein the full spectrum is decomposed into peak components and continuum background components; instructions to identify one or more elements based on the peak components; instructions to modify a generalized set of elemental standards to generate a constrained set of elemental standards based on the one or more elements; and instructions to perform a fitting of the full spectrum to the constrained set of elemental standards to determine an elemental composition at the first depth of the subsurface formation.

Implementation #17: The non-transitory, computer-readable medium of Implementation #16, wherein the full spectrum includes neutron-induced gamma-ray spectra.

Implementation #18: The non-transitory, computer-readable medium of Implementation #16 or 17 further comprising: instructions to separate the continuum background components from the full spectrum to obtain the peak components; instructions to acquire peak information from the peak components, the peak information including a centroid of one or more peaks within the peak components, magnitude of one or more peaks within the peak components, correlation of two or more peaks within the peak components, or any combination thereof are used to identify the one or more elements; instructions to identify a presence or absence of the one or more elements to be used in the fitting based on the peak information; and instructions to generate the constrained set of elemental standards based on the presence or absence of the one or more elements.

Implementation #19: The non-transitory, computer-readable medium of any one or more of Implementation #16-18 further comprising: instructions to separate the continuum background components from the full spectrum to obtain the peak components; instructions to determine centroids of one or more peaks in one or more high energy regions; instructions compare the centroids to the generalized set of elemental standards to identify the one or more elements; and instructions to modify a the generalized set of elemental standards with the one or more elements to generate the constrained set of elemental standards.

Implementation #20: The non-transitory, computer-readable medium of any one or more of Implementation #16-19 further comprising: instructions to separate the continuum background components from the full spectrum to obtain the peak components; instructions to determine a ratio of a first count window and a second count window based on the peak components, wherein the first count window corresponds to a gamma ray associated with a first element and the second count window corresponds to the gamma ray associated with a second element; and instructions to modify the generalized set of elemental standards with the first element or the second element based on the ratio to generate the constrained set of elemental standards.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

1. A method comprising:
obtaining, via one or more sensors positioned in a wellbore formed in a subsurface formation, a full spectrum of the subsurface formation at a first depth, wherein the full spectrum is decomposed into peak components and continuum background components;
identifying one or more elements based on the peak components;
modifying a generalized set of elemental standards to generate a constrained set of elemental standards based on the one or more elements; and
performing a fitting of the full spectrum to the constrained set of elemental standards to determine an elemental composition at the first depth of the subsurface formation.

2. The method of claim 1, wherein the full spectrum includes neutron-induced gamma-ray spectra.

3. The method of claim 1 further comprising:
separating the continuum background components from the full spectrum to obtain the peak components;
acquiring peak information from the peak components, the peak information including a centroid of one or more peaks within the peak components, magnitude of one or more peaks within the peak components, correlation of two or more peaks within the peak components, or any combination thereof are used to identify the one or more elements;
identifying a presence or absence of the one or more elements to be used in the fitting based on the peak information; and
generating the constrained set of elemental standards based on the presence or the absence of the one or more elements.

4. The method of claim 1 further comprising:
separating the continuum background components from the full spectrum to obtain the peak components;
determining centroids of one or more peaks in one or more high energy regions;
comparing the centroids to the generalized set of elemental standards to identify the one or more elements; and
modifying a the generalized set of elemental standards with the one or more elements to generate the constrained set of elemental standards.

5. The method of claim 1 further comprising:
separating the continuum background components from the full spectrum to obtain the peak components;
determining a ratio of a first count window and a second count window based on the peak components, wherein the first count window corresponds to a gamma ray associated with a first element and the second count window corresponds to the gamma ray associated with a second element; and
modifying the generalized set of elemental standards with the first element or the second element based on the ratio to generate the constrained set of elemental standards.

6. The method of claim 1, wherein the full spectrum is obtained in a capture spectrum or an inelastic spectrum.

7. The method of claim 1, further comprising:
directing an operation to modify at least one of a downhole operation or a downhole attribute in the wellbore based on the elemental composition.

8. The method of claim 1, further comprising:
modify at least one of a downhole operation or a downhole attribute in the wellbore based on the elemental composition.

9. A system comprising:
one or more sensors positioned in a wellbore formed in a subsurface formation;
a processor; and
a computer-readable medium having instructions stored thereon that are executable by the processor, the instructions including,
instructions to obtain, via one or more sensors positioned in a wellbore formed in a subsurface formation, a full spectrum of the subsurface formation at a first depth, wherein the full spectrum is decomposed into peak components and continuum background components,
instructions to identify one or more elements based on the peak components,
instructions to modify a generalized set of elemental standards to generate a constrained set of elemental standards based on the one or more elements, and
instructions to perform a fitting of the full spectrum to the constrained set of elemental standards to determine an elemental composition at the first depth of the subsurface formation.

10. The system of claim 9, wherein the full spectrum includes neutron-induced gamma-ray spectra.

11. The system of claim 9 further comprising:
instructions to separate the continuum background components from the full spectrum to obtain the peak components;
instructions to acquire peak information from the peak components, the peak information including a centroid of one or more peaks within the peak components, magnitude of one or more peaks within the peak components, correlation of two or more peaks within the peak components, or any combination thereof are used to identify the one or more elements;
instructions to identify a presence or absence of the one or more elements to be used in the fitting based on the peak information; and
instructions to generate the constrained set of elemental standards based on the presence or the absence of the one or more elements.

12. The system of claim 9 further comprising:
instructions to separate the continuum background components from the full spectrum to obtain the peak components;
instructions to determine centroids of one or more peaks in one or more high energy regions;
instructions compare the centroids to the generalized set of elemental standards to identify the one or more elements; and
instructions to modify the generalized set of elemental standards with the one or more elements to generate the constrained set of elemental standards.

13. The system of claim 9 further comprising:
instructions to separate the continuum background components from the full spectrum to obtain the peak components;
instructions to determine a ratio of a first count window and a second count window based on the peak components, wherein the first count window corresponds to a gamma ray associated with a first element and the second count window corresponds to the gamma ray associated with a second element; and
instructions to modify the generalized set of elemental standards with the first element or the second element based on the ratio to generate the constrained set of elemental standards.

14. The system of claim 9, wherein the full spectrum is obtained in a capture spectrum or an inelastic spectrum.

15. The system of claim 9, further comprising:
instructions to direct an operation to modify at least one of a downhole operation or a downhole attribute in the wellbore based on the elemental composition.

16. A non-transitory, computer-readable medium having instructions stored thereon that are executable by a processor, the instructions comprising:
instructions to obtain, via one or more sensors positioned in a wellbore formed in a subsurface formation, a full spectrum of the subsurface formation at a first depth, wherein the full spectrum is decomposed into peak components and continuum background components;
instructions to identify one or more elements based on the peak components;
instructions to modify a generalized set of elemental standards to generate a constrained set of elemental standards based on the one or more elements; and
instructions to perform a fitting of the full spectrum to the constrained set of elemental standards to determine an elemental composition at the first depth of the subsurface formation.

17. The non-transitory, computer-readable medium of claim 16, wherein the full spectrum includes neutron-induced gamma-ray spectra.

18. The non-transitory, computer-readable medium of claim 16 further comprising:
instructions to separate the continuum background components from the full spectrum to obtain the peak components;
instructions to acquire peak information from the peak components, the peak information including a centroid of one or more peaks within the peak components, magnitude of one or more peaks within the peak components, correlation of two or more peaks within the peak components, or any combination thereof are used to identify the one or more elements;
instructions to identify a presence or absence of the one or more elements to be used in the fitting based on the peak information; and
instructions to generate the constrained set of elemental standards based on the presence or absence of the one or more elements.

19. The non-transitory, computer-readable medium of claim 16 further comprising:
instructions to separate the continuum background components from the full spectrum to obtain the peak components;
instructions to determine centroids of one or more peaks in one or more high energy regions;
instructions compare the centroids to the generalized set of elemental standards to identify the one or more elements; and
instructions to modify the generalized set of elemental standards with the one or more elements to generate the constrained set of elemental standards.

20. The non-transitory, computer-readable medium of claim 16 further comprising:
instructions to separate the continuum background components from the full spectrum to obtain the peak components;
instructions to determine a ratio of a first count window and a second count window based on the peak components, wherein the first count window corresponds to a gamma ray associated with a first element and the second count window corresponds to the gamma ray associated with a second element; and
instructions to modify the generalized set of elemental standards with the first element or the second element based on the ratio to generate the constrained set of elemental standards.
